(19) United States
(12) Patent Application Publication
(10) Pub. No.: US 2010/0317281 A1
(43) Pub. Date: Dec. 16, 2010

(54) PTAC LOUVER

(76) Inventors: David Sperandio, Monett, MO (US); David Szydioski, Pierce City, MO (US)

Correspondence Address: LATHROP & GAGE LLP, 1845 S. NATIONAL, P.O. BOX 4288, SPRINGFIELD, MO, 65808-4288, US

(21) Appl. No.: 12/815,152

(22) Filed: Jun. 14, 2010

Related U.S. Application Data
(60) Provisional application No. 61/268,418, filed on Jun. 12, 2009.

(51) Int. Cl. E06B 7/08

(52) U.S. Cl. 454/224; 52/473

(57) ABSTRACT

A PTAC louver assembly for glazing in a window wall which is field adjustable for fastening to a PTAC sleeves provided by different manufacturers. A unique system includes inwardly directed flanges which form a box within a box when mated to the PTAC sleeve. Sealant between the flanges and the PTAC sleeve provide a substantially water tight assembly. By sealing between the sleeve and the lower sill flange, the need to seal the sleeve face and to align weep holes in the PTAC sleeve is no longer necessary. Blank-off panels are filled with high temperature insulation which allows the louver system to be painted and baked after assembly. A unique louver blade assembly uses sliding retention bars with aligned notches to receive and capture louver blades using a clamping force.

### RELATED APPLICATIONS

This application claims benefit of U.S. Patent Application Ser. No. 61/268,418, filed Jun. 12, 2009, the disclosure of which is incorporated herein by reference.

### FIELD OF THE INVENTION

The present disclosure is directed to a louver system for use with packaged terminal air conditioner (PTAC) system, sometimes referred to as single packaged air conditioning systems. More specifically, the PTAC louver system is mountable into a commercial window wall for an aesthetically pleasing installation, eliminates known problems with water infiltration and is field adjustable.

### BACKGROUND

Packaged terminal air conditioning systems are well known and widely used in commercial buildings. They are particularly identified with transient housing such as hotels and motels and are frequently used in assisted living facilities. PTAC systems are self-contained air conditioning and heat units designed to heat and cool a limited space such as a hotel room or very small apartment. PTAC systems are installed through the exterior wall of the building such that the air inlet portion of the system generally projects outward beyond the outer wall of the building and the air venting portion of the system is positioned inward through the interior wall of the building. Generally, the heating and cooling mechanism is housed within a metal sleeve.

PTAC systems are most commonly found in buildings that are three stories or less. Typically, taller buildings will have central HVAC systems. PTAC systems have several highly desirable attributes. They are generally less expensive than HVAC systems, are generally simple to install, repair and replace and easily allow the occupants of each individual room to independently control their own temperature setting.

There are, however, several drawbacks to PTAC systems. Often, architects, designers and building owners find PTAC systems to be unsightly with individual units projecting from each room of the building. Further, where the air inlet portion of the PTAC system is recessed in the building so that the louver is flushly mounted to the building façade these systems are prone to water infiltration and failure to drain accumulated water and condensation. This is particularly true with existing PTAC systems mounted in commercial window walls. An installer must achieve a perfect seal between the louver and the outside edge of the PTAC sleeve and take care not to inadvertently plug weep holes provided through the PTAC sleeve. Further, the installer typically must tilt the sleeve outward to facilitate drainage and eliminate water entrapment. Water infiltration around the PTAC sleeve will generally degrade the building wall at an accelerated rate. Moreover, water that can accumulate in the PTAC sleeve may be diverted to the interior of the room and it is not uncommon for drywall, flooring and other building materials to become damaged.

Another problem with PTAC systems is that each manufacturer generally utilizes different mounting configurations on the PTAC sleeve and it is impossible to select and mount existing louvers in a window wall until the manufacturer for the PTAC sleeve is known. PTAC systems are commercially manufactured in uniform sizes. For example, one common configuration is a unit 42 inches wide by 16 inches tall. The exterior louvers, as manufactured by different companies, however, are provided with different installation bolt patterns or attachment features, have diffuser grills in specific fixed locations, and pre-formed sill notches to align with weeps. Accordingly, designers and builders have to specify which PTAC manufacturer will be used very early on in the building design and construction phase to ensure that the louver preparation will match the PTAC sleeve. This may not be a problem where PTAC installation includes positioning the PTAC through the building wall and fastening an exterior louver directly to the sleeve and independent of glass or glazing. The building trend, however, is to integrate the exterior PTAC louver into the exterior window wall so that the louver is substantially flushly mounted thereto. This installation technique is intended to increase the aesthetic desirability of PTAC use by integrating the louver flushly with the building exterior and eliminating unsightly detached louvers. With this mounting method for existing louvers, it is very difficult to achieve the necessary face seal between the louver and the sleeve. The instant invention eliminates the need for this face seal with a inner box formed by louver frame members into which the PTAC sleeve is positioned. A seal can easily be formed between the frame members and the sleeve.

Currently, for PTAC system installation into a building which includes a window wall, it is imperative that the building designer specify very early on in the design and construction process the manufacturer of the PTAC systems to be used. This ensures that the correct louver preparation can be fabricated so that the louver mounting mechanisms will mate to the PTAC sleeve of the selected PTAC manufacturer.

To date, there are no known PTAC louvers being manufactured which are readily adjustable for mounting to a variety of PTAC sleeves available from different PTAC manufacturers. Moreover, there appears to be virtually no effort to limit or control water intrusion through existing exterior PTAC louvers other than to recommend the liberal use of sealants between the louver and the building facade or the louver and the PTAC sleeve.

Turning now to the issue of PTAC louver construction, there have historically been several manufacturing difficulties. The first difficulty is that most available PTAC louvers can only be mounted to a PTAC sleeve manufactured by a known PTAC manufacturer. Heretofore, there has been no effort to provide field adjustment of these systems. Next, during the manufacturing process it is extremely difficult to properly orient and mount the louver blades. The accepted method within the industry is to provide parallel louver blade retention bars. Each bar is provided with a series of horizontal slots in serial alignment along the vertical axis of bar. The retention bars are substantially U-shaped with the retention slots formed through the lowermost portion of the U so that they project generally upward into each of the legs of the U-shaped bar. A plurality of louver blades are positioned within the retention bar slots. A roller or similar device is then used to mechanically crimp that portion of each louver blade that projects inwardly into the U-shaped retention bars. This method, while seemingly simple, provides substantial complexities.

If any individual louver blade is misaligned or becomes misaligned or is damaged during the crimping process, it is generally necessary to discard the entire louver assembly and start over. Further, if a plurality of louver blades are improperly aligned either horizontally or vertically during the crimping process, the louver assembly will have an improper installation and a poor aesthetic appeal.

It is highly desirable to provide a louver blade mounting assembly which allows the blades to be firmly secured within the louver assembly during the manufacturing process, but in the event of an improper alignment, or other manufacturing problem a system that allows individual blades to be repositioned or easily removed and replaced. The instant invention provides for such a process.

### BRIEF DESCRIPTION OF DRAWINGS

FIG. 1 is a cross-sectional view of prior art showing a traditional mounted PTAC sleeve with a unitary architectural grill.

FIG. 2 is a cross-sectional view of prior art showing a flush mounted PTAC sleeve with louver within a window wall.

FIG. 3 is a plan view of the exterior of the inventive PTAC louver assembly.

FIG. 4 is a vertical cross-sectional view taken along line 4-4 shown in FIG. 3.

FIG. 5 is a horizontal cross-sectional view taken along line 5-5 shown in FIG. 3.

FIG. 6 is a detailed cross-sectional view of the header assembly within 6-6 of FIG. 4.

FIG. 7 is a detailed cross-sectional view of the sill assembly within 7-7 of FIG. 4.

FIG. 8 is a detailed cross-sectional view of the jamb assembly within 8-8 of FIG. 5.

FIG. 9 is a plan view of the interior of the inventive PTAC louver assembly showing the orientation of retention bars and associated air diffusers.

### DETAILED DESCRIPTION

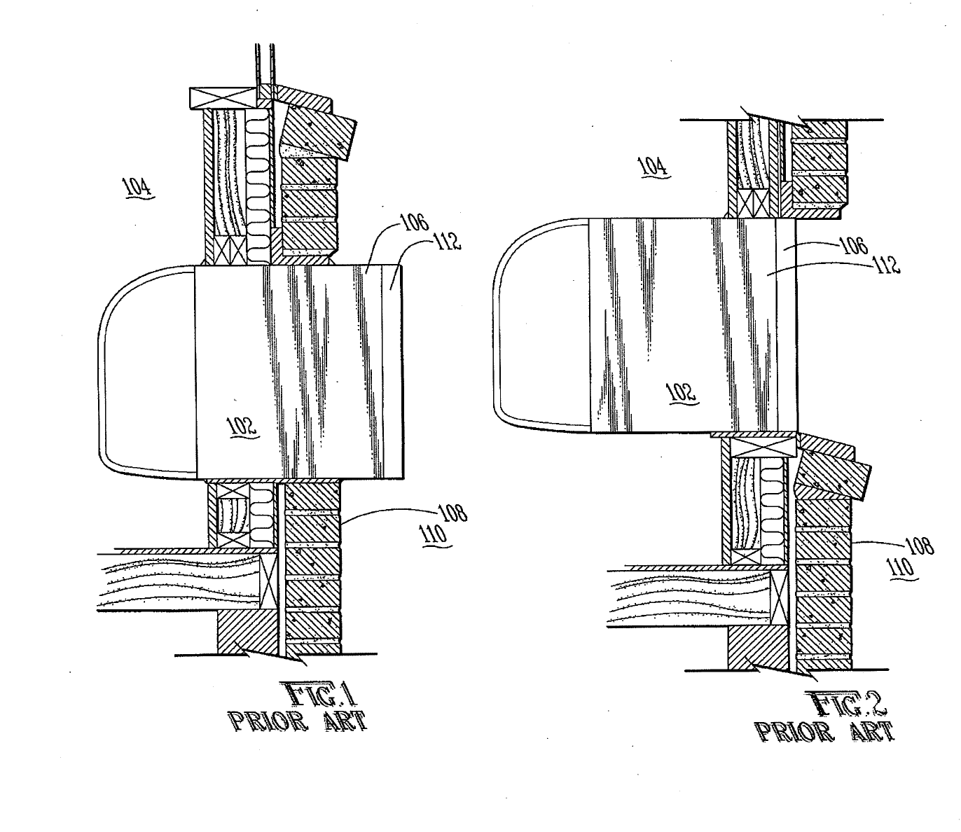

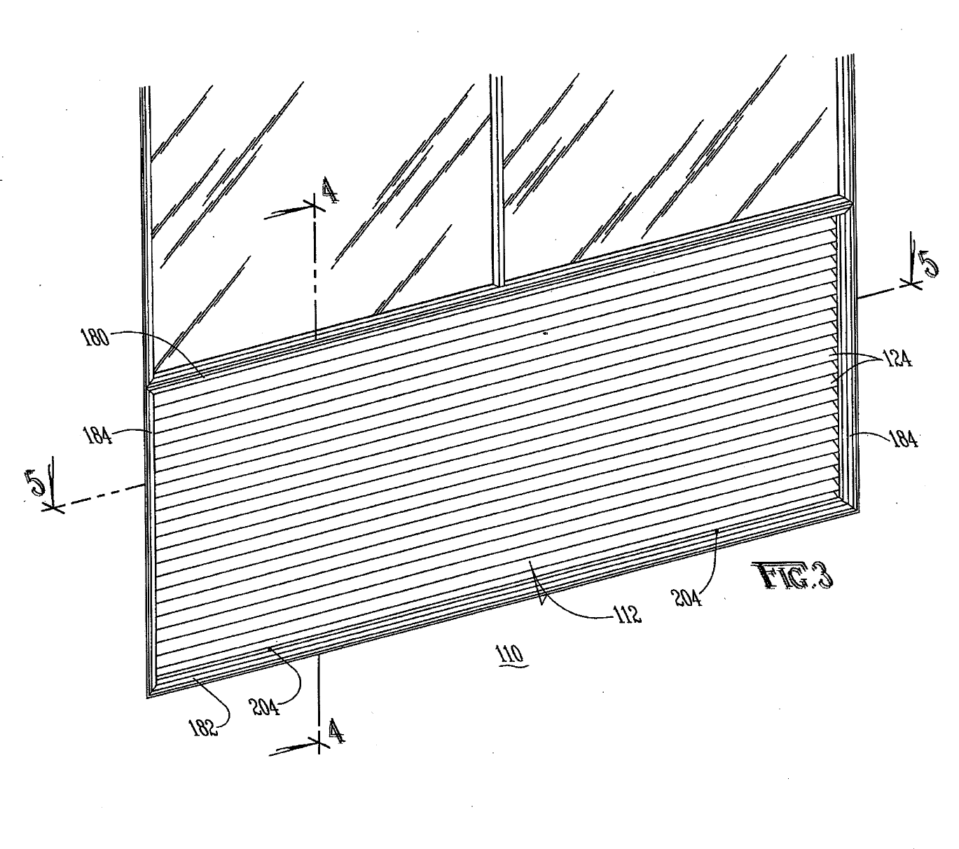

Referring now generally to FIGS. 1 and 2, traditional mounting methods for PTAC systems within a wall of a building are shown. A PTAC system 102 provides heating and air conditioning to a room 104 and is somewhat similar to a traditional window mounted air conditioning unit in that it is self-contained. The PTAC system 102 generally includes a sleeve 106 which is a rectangular metal box positioned through and mounted in an exterior wall 108 of the building. Air is drawn from the exterior of the building 110 through the PTAC system 102 where it is either heated or cooled and expelled into the interior 104 of the building. The instant invention is drawn to the louver or exterior grill 112 which covers the outermost or exterior portion of the PTAC system 102. The louver 112 allows air to be drawn into the PTAC system while limiting rain and other elements from entering the PTAC sleeve 106. The louver 112 also provides a mechanism to quickly drain water and condensation from the PTAC sleeve 106. Moreover, the louver 112 provides an aesthetic appearance to the PTAC installation.

FIG. 1 shows a traditional PTAC installation where the PTAC sleeve 106 is positioned through the building wall 108 with a substantial portion of the system exterior to the building. A very simply unitary grill 112 is used to cover the outside of the PTAC system. FIG. 2 shows an alternative installation that is often preferred by architects and designers. The installation shown in FIG. 2 brings the entire visible portion the PTAC sleeve 106 interior to the building such that the grill mounted on the exterior of the building is substantially flush with the exterior wall 108 of the building.

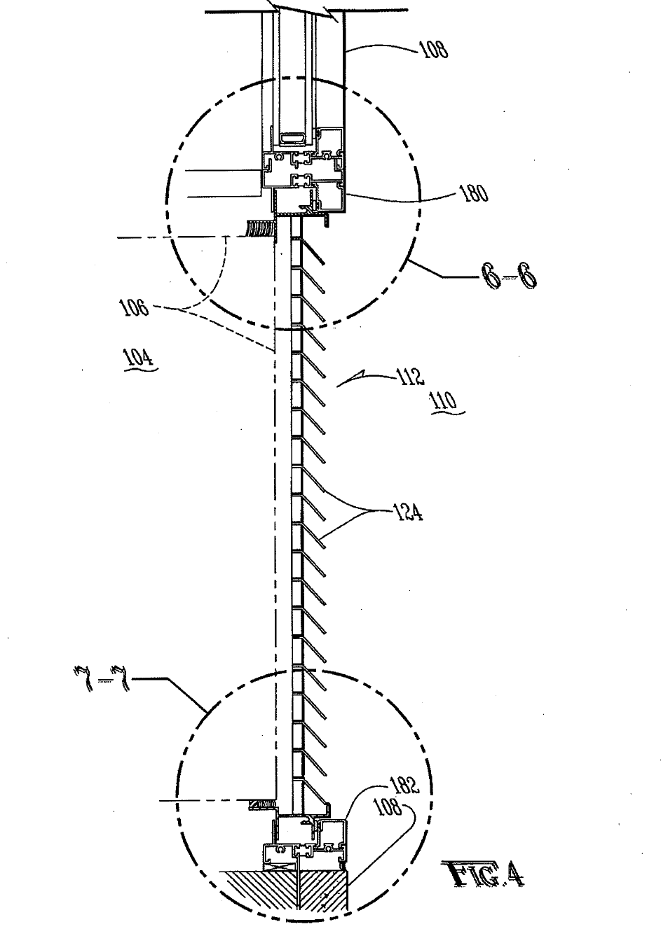

Because many designers and architects do not like the appearance of grills fastened to the exterior walls of buildings, and because of installation limitations and water leaking issues, it is greatly preferred to integrate the grill or louver system within a window wall as shown in FIG. 3. It is to be understood that the PTAC louver described and claimed herein is intended for use with a window wall and will typically be glazed into the window wall by the manufacturer. This design method blends the louver system in with the remainder of the window, and when the louver is finished to match or complement the remainder of the building exterior, the presence of PTAC systems in the building may go unnoticed based on the exterior or outside appearance of the building.

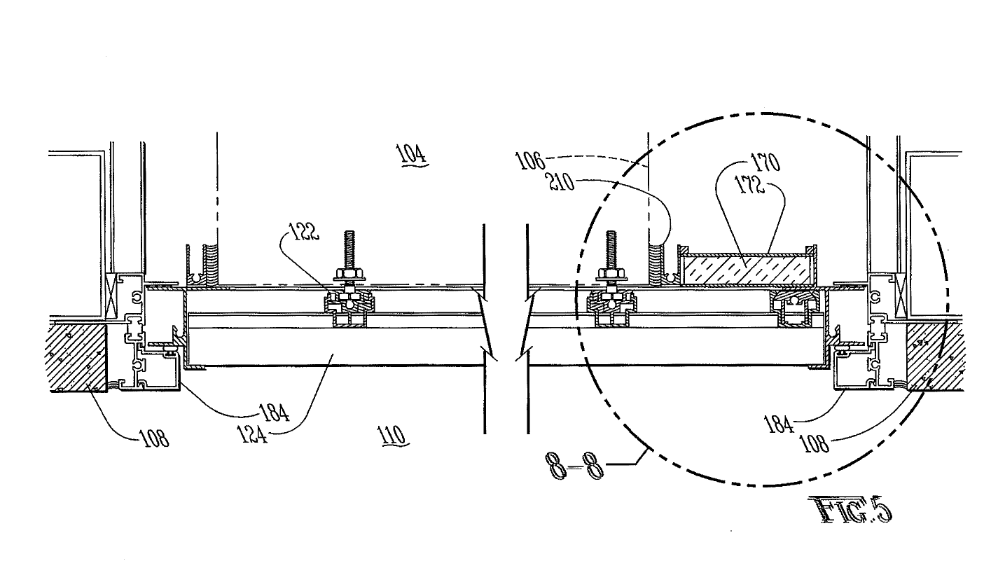

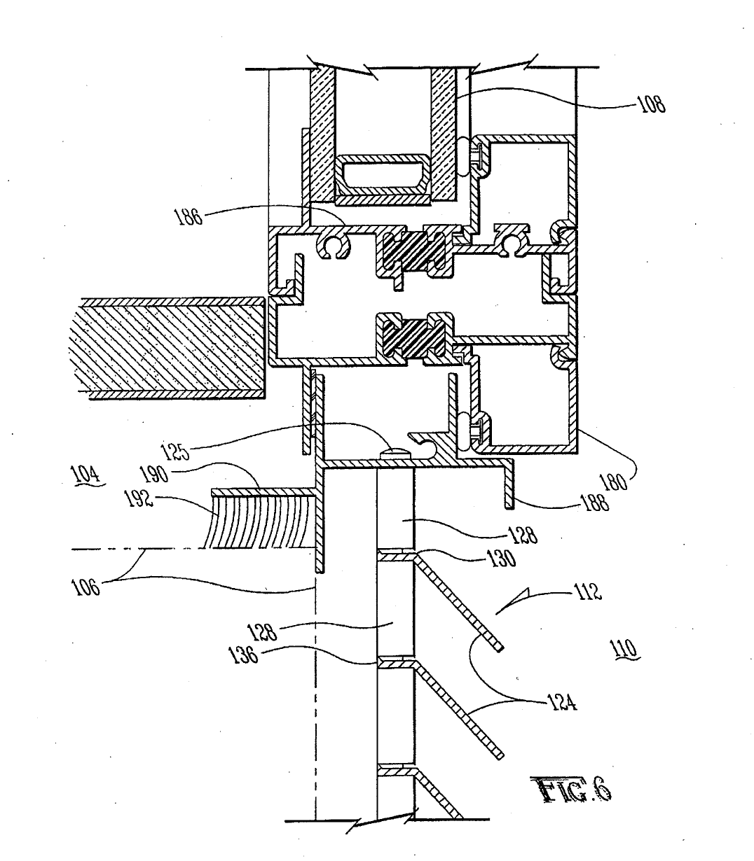

Now referring generally to FIGS. 3 through 9, the PTAC louver assembly 120 of the instant invention is shown. The PTAC louver assembly 120 of the instant invention includes innovative louver blade retention bars 122. As best shown in FIG. 5, multiple louver retention bars 122 are utilized in each PTAC louver 120 to facilitate proper blade retention and orientation of the individual louver blades 124. The inventive louver blade retention bars 122 further comprise an inner retention bar or backer 126 inverted and nested within an outer retention bar or strut 128. Each backer 126 and strut 128 may be substantially U-shaped although it is preferred that the backer 126 is T-shaped. The backer 126 is necessarily smaller in dimension than the outer retention bar 128. Both the backer 126 and the strut 128 are provided with a plurality of horizontal blade retention slots 130 aligned vertically along the length of the bar. On the strut 128, the slots 130 are formed through the “U” of the base 132 and project generally into the legs or stems 134 of the U-shaped bar. On the backer 126, the slots 130 are formed through the opposed legs 134 of the U-shaped bar toward the base 132 of the “U”. Where the preferred “T” shaped backer 126 is used, the stem or leg 134 of that bar is nested into the lower portion 132 of the outer U-shaped strut 128. In that configuration, the slots 130 in the strut 128 are serially aligned with slots 130 formed along the leg of the T-shaped backer 126.

During the manufacturing process, the backer 126 is nested inside the strut 128 and the retention slots 130 of the backer 126 and strut 128 are aligned. A PTAC louver blade 124 is inserted into each slot 130 so that it projects inwardly through the retention slot of the outer strut 128 and into the slot 130 of the backer 126. It is understood that multiple retention bars 122 are used along the length of the PTAC louver blades 126. At least two are necessary, and three or more are preferred, to allow for the necessary orientation, retention and stability of the PTAC louver blades 124.

When the individual PTAC louver blades 124 have been inserted in the retention slots 130 of both the strut 128 and aligned backer 126 and each blade 124 has been properly oriented such that each louver blade 124 is in substantial alignment in all directions, the backer 126 is moved linearly within the strut 128 by force. This movement causes a lateral offset of the backer slots 130 respective the strut slots 130 which results in each individual louver blade 124 becoming mechanically captured by the clamping movement of the backer slots with respect to the strut slots.

Because the dimensions of each louver blade 124 and the retention bar slots 130 are generally quite small, a very small movement of the backer 126 within the strut 128 is necessary to capture and retain the louver blades 124. Further, each louver blade 124 includes a nub 136 formed along the inner length which is captured within a slot 130 of the retention bar. This nub 136 substantially increases the retention force created when the backer 126 and strut 128 are offset and clamped during the fastening process. If any of the louver blades 124 become misaligned or damaged during the process, the backer 126 is simply returned to its original position so that each louver blade 124 can be removed or repositioned. Once the louver blades 124 have been properly captured and are in the correct orientation, the backer 126 is retained in the desired position with set screws 125 through the louver frame extrusion. This fastener can also be used to mechanically move the backer 126 within the strut 128 to exert the desired clamping force on each louver blade.

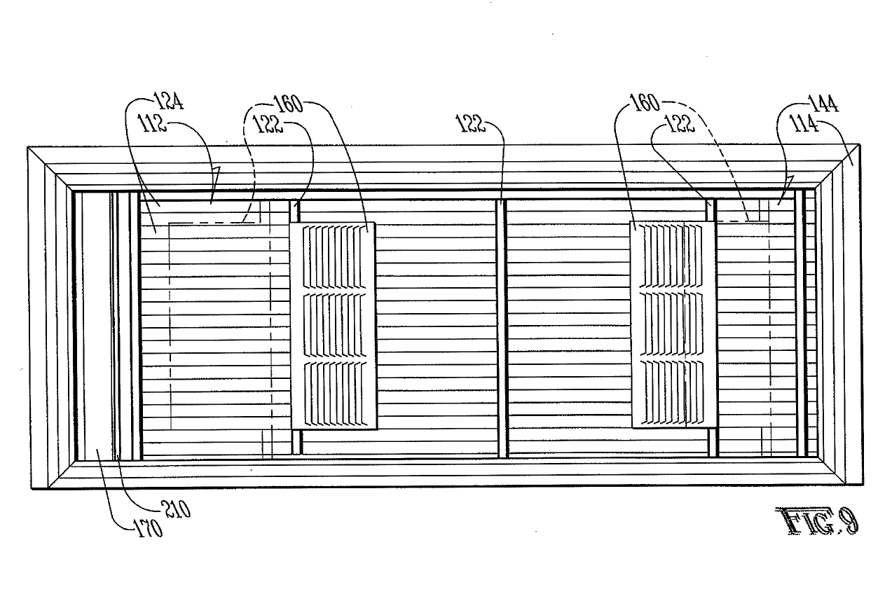

For adjustability, the innovative PTAC louver 120 includes several novel features. It is understood that the inventive PTAC louver is specifically configured for use in a window wall 138 and is not a louver that is simply mounted or fastened to the exterior portion of a PTAC sleeve 106. As such, the PTAC louver can be manufactured for integration into a window wall 138 by a window manufacturer. If the specific PTAC manufacturer is unknown at the time of window construction, it is impracticable to correctly orient the mounting features onto the PTAC louver to mate with a specific sleeve of a manufacturer. The most common method for mounting the exterior louver or grill 112 onto the PTAC sleeve is to provide bolt holes through an inwardly directed exterior flange portion of the sleeve itself, as shown in FIGS. 5 and 8. The louver 112 is then aligned to the PTAC sleeve 106 and fastened with bolts passing through the bolt holes formed in the sleeve into a threaded bolt receiver or nut pre-positioned on the inner surface of the louver, preferably provided on the louver retention bars.

In the instant invention, the mounting process provides substantial adjustability. No permanently placed bolt receivers are provided on the interior surface of the louver 112. Rather, races 142 are provided on the inner-facing surface of each at least two of the backers 126. These races 142 are formed on backers 126 having a T-shape and the races are generally oriented inward toward the PTAC sleeve as shown in FIG. 8. When a threaded nut 146, or similar fastening device, is placed within the race 142, it can be moved up or down along the length of the race 142. When the louver 112 is to be mounted to the PTAC sleeve 106, threaded studs 148 are provided and positioned within the nut 146 positioned in the race 142 such that the threaded portion of the stud 148 is inwardly projecting. The louver retention bars 122 are moved horizontally along the louver blades until the associated threaded stud 148 is generally horizontally aligned with the holes 140. The nuts 146 and associated stud 148 are then moved vertically within the race so that they align with the mounting holes 140 which are factory provided in the PTAC sleeve 106. The threaded studs 148 are passed through these holes 140 and fastened in place with conventional fasteners such as nuts, wing nuts or the like opposing the nut 146. It is understood and appreciated that a variety of different fasteners can be used to connect the louver to the PTAC sleeve without departing from the invention.

As shown in FIG. 9, PTAC louvers are often provided with air diffusers 160 which prevent or substantially limit the convection of air within the PTAC sleeve 106. Again, the manufacturer of the PTAC system must be known to properly position air diffusers 160 on a louver. The inventive louver, however, provides diffusers 160 on the interior portion 144 of the louver assembly 112 which can be moved laterally along the length of the louver 112 to accommodate the dimensions provided by different PTAC manufacturers. The diffusers 160 are mounted on the interior portion of a louver blade retention bar 122. It is preferred for field adjustability that the diffusers 160 are mounted to separate blade retention bars 122 from those bearing fasteners 148 used to connect the louver 112 to the PTAC sleeve 106 but it is understood that the diffusers 169 can be mounted on common bars 122 with the fasteners 148. Where separate blade retention bars 122 from are used to mount the air diffusers 160, it is preferred to eliminate the backer 126 and use only the strut 128 as this allows easy horizontal movement of the bar 122 along the louver blades 124. Where a complete blade retention bar 122 is used for mounting the diffuser 160, horizontal movement is accomplished by releasing the set screws 125 which hold the retention bars 122 in place on the louver blades 124. The bar 122 is then moved horizontally along the length of the PTAC louver to the desired position and the set screws 125 are tightened to retain the retention bar 122 and associated air diffuser 160 in the desired horizontal position. Vertical movement of the diffuser 160 is accomplished by vertical positioning of fasteners used to mount the diffuser onto the bar 122.

When PTAC louvers 112 are glazed in window walls 138, the dimensions for the louver specified by the architect or designer are often different from the dimensions of the PTAC louver 112 necessary for attachment to the PTAC sleeve 106. Generally, the dimensions of the louver 112 will be larger than the dimensions of the PTAC sleeve 106. Accordingly, blank-off panels 170 are often provided on the inner surface 144 of the louver 112 as best shown in FIGS. 5 and 9. These blank-off panels 170 close any gaps existing between the PTAC sleeve 106 and the outer dimensions of the PTAC louver 112 and prevent air and water from passing through the louvers 112 around the periphery of the PTAC sleeve 106. The blank-off panels 170 allow PTAC louver 112 to be manufactured in sizes much wider and taller than PTAC sleeve 106 assemblies for aesthetic purposes. Generally, the blank-off panels 170 are filled with insulation. The instant device incorporates a high temperature insulation 172 in the blank-off panels 170 so that the insulation 172 can withstand baking temperatures of up to 400 degrees Fahrenheit during the louver painting process. In the past, it has been necessary to paint different parts of the PTAC louver assembly, bake on the paint at high temperatures and then assemble the louver because of the propensity to melt insulation in the blank-off panels. The use of high temperature resistant insulation such as polyisocyanurate foam core allow the PTAC louver of the instant invention to be fully assembled prior to painting which substantially decreases labor and the overall cost of manufacturing.

Turning now to the specific manufacture of the inventive device, a substantially rectangular frame 114 for the PTAC louver 112 is formed. This frame member 114 will generally be extruded aluminum. The frame extrusion will have a header 180, a sill 182 and opposed sides or jambs 184 which, when joined together, form the substantially rectangular frame 114. The frame extrusion 114 for the headers 180, sill 182 and jambs 184 will include a generally U-shaped seat 186 which is configured for mounting in place of glazing a section of glass into the frame of a window wall 138. Generally the PTAC louvers 112 of the instant invention will be manufactured and then placed into a window wall 138 by the window manufacturer.

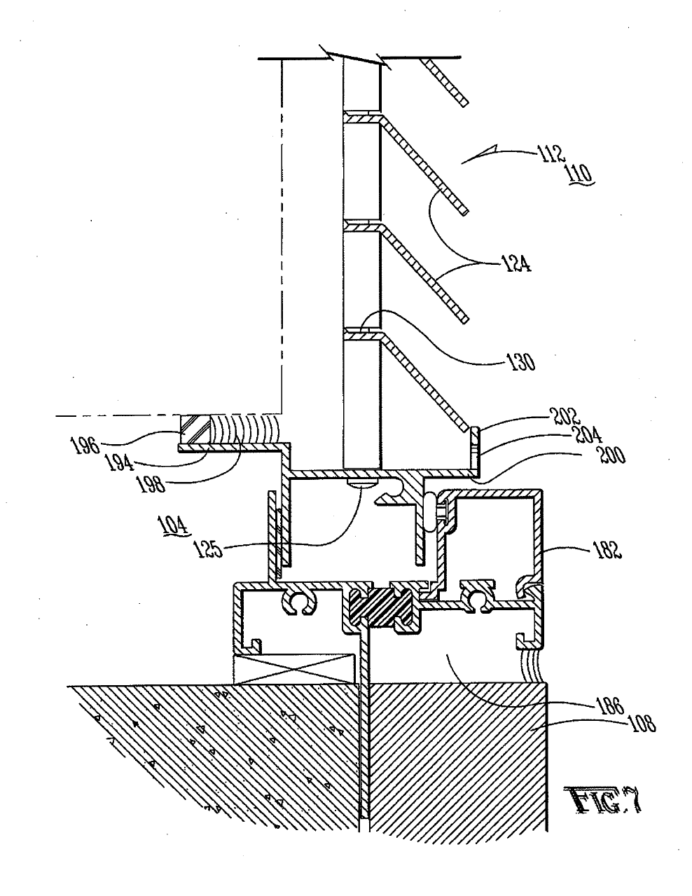

As best shown in FIG. 6, the header 180 of the louver frame 114 includes an exteriorly positioned flange 188 which depends downward as shown. This downwardly projecting flange 188 directs protects the louver blades 124. The header also includes an inwardly projecting flange 190 which is intended to overlie the PTAC sleeve 106 as shown. The inner flange 190 allows a seal 192 to be formed between the PTAC sleeve 106 and the header 180, and further acts to stabilize the sleeve 106 within the wall assembly 138.

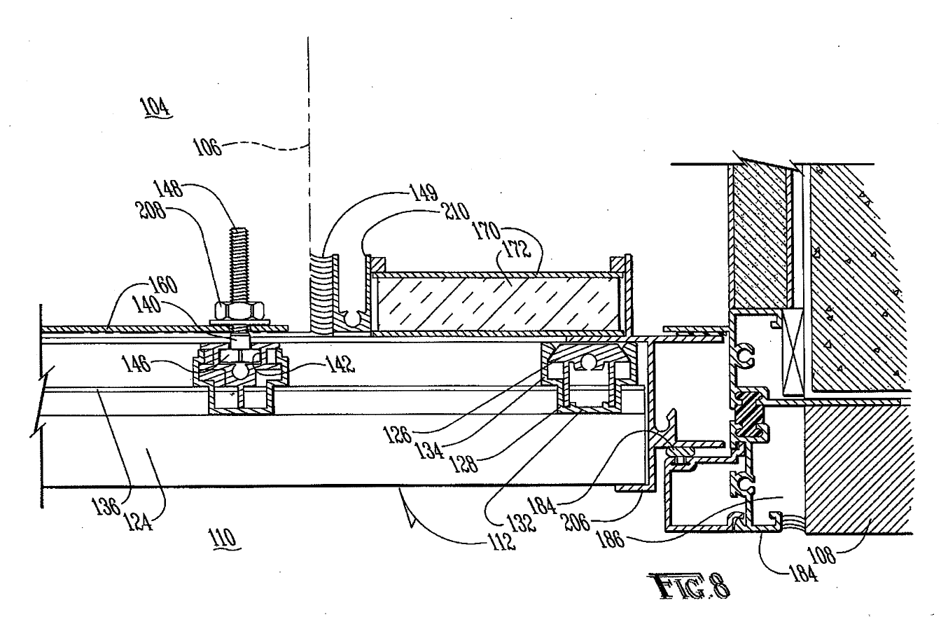

Referring now to FIG. 7, the sill 182 of the PTAC louver frame 114 is shown. An inwardly projecting flange 194 underlies the lowermost portion of the PTAC sleeve 106. A shim 196 is provided between the inner frame flange 194 and the PTAC sleeve 106 as shown to create a workable joint thickness. Sealant 198 must be field installed in the joint between the PTAC sleeve 106 and the flange 194 to eliminate water intrusion. During installation it is the PTAC manufacturer's requirement that the PTAC sleeve 106 have a modest slope oriented outward 110 to facilitate water drainage from the sleeve 106 into the louver assembly 112. An exteriorly oriented flange 200 includes an upward projecting bar 202. A weep 204 is formed in the bar 202 to allow water passing into the louver 112 to drain exterior the louver assembly. Notches 204 provided intermittently along the width of the bar 202 will properly serve as a weep for the louver assembly. The use of these notches 204 is advantageous in that alignment of the louver weep with the weeps provided in the PTAC sleeve is not necessary. Because the inner flange 194 underlies the PTAC sleeve 106 and a sealant 198 is provided between the sleeve and the flange, any water passing from the weep formed in the PTAC sleeve drains into the louver assembly and will migrate to the weep notch 204 formed in the exterior bar 202 of the louver assembly 112. Accordingly, the weep of the PTAC sleeve does not have to be aligned with the weep formed in the PTAC louver.

Now turning to FIG. 8, the louver assembly is viewed from the top such that each side or jamb 184 of the frame 114 is in view. The frame sides 184 include U-shaped rails 186 for glazing into a window 138. The side frame members 184 also include outwardly projecting retention members 206 which overlie the ends of the louver blades 124. This retention member 206 provides aesthetic appearance to the louver in that the blade ends are not viewable from the exterior. Moreover, they protect the blade ends from damage.

As shown in FIGS. 5 and 8, fasteners 148 are provided for attaching the PTAC louver 112 directly to the PTAC sleeve 106. The fasteners 148 are mounted into races 142 which are formed on the innermost surface of the backer 126. A fastener, such as a hex nut 146 is positioned within each race 142. The nut 146 slides within the race 142 into the necessary vertical position to match mounting holes provided through the PTAC sleeve 106 by the manufacturer. Threaded studs 148 or other proper fasteners are then used to secure the PTAC sleeve 106 to the provided louver. A hex nut or similar fastener secures the threaded stud 148 through the sleeve. As needed, the retention bars 122 can be moved horizontally to further align the fasteners 148 with the holes in the PTAC sleeve 106.

A blank-off panel 170 is shown in FIGS. 5 and 8. It is understood that a second blank-off panel, while not shown, would likely be provided on the other side of the PTAC sleeve for uniformity. One or more blank-off panels can be used. It is further understood that the blank-off panel dimensions can range widely depending on the overall dimensions of the PTAC louver designated by the architect or designer. Each panel is provided with high temperature insulation 172. Custom extruded aluminum meeting rails 210 are preferably used between the blank-off panels 170, and the sides of the PTAC sleeve 116, for a further customizable fit. The meeting rails 210 and the inwardly directed flanges 190, 194 provided on the header and sill cooperate to form a box-shaped receiver into which the PTAC sleeve is positioned and mounted. This forms a box within a box connection between the PTAC louver 112 and the PTAC sleeve 106. As shown, it is preferred that sealant 198 is applied between the meeting rail of the louver and the PTAC sleeve. This box within a box configuration results in a desirable fit between the sleeve 106 and the louver 112 and facilitates a uniform seal entirely around the sleeve.

It should be understood that this invention is not limited to the embodiments disclosed herein but is capable of numerous rearrangements, modifications and substitutions without departing from the spirit of the inventions which is only limited by the appended claims.

What is claimed is:

1. A PTAC louver assembly having a frame which can be glazed into a window wall.

2. The PTAC louver of claim 1 wherein the frame is substantially rectangular and includes a header, a sill and a pair of opposed jambs, and a plurality of louver blades.

3. The PTAC louver of claim 2 wherein the header includes an inwardly projecting flange which forms a joint between the exterior upper surface of a PTAC sleeve and the frame.

4. The PTAC louver of claim 1 wherein the header includes an inwardly projecting flange which forms a joint between the exterior upper surface of a PTAC sleeve and the frame and an exterior flange projecting generally outward the header to protect the louver blades.

5. The PTAC louver of claim 2 wherein the sill includes an inwardly projecting flange which forms a joint between the exterior lower surface of a PTAC sleeve and the frame.

6. The PTAC louver of claim 2 wherein the sill includes an inwardly projecting flange which forms a joint between the exterior lower surface of a PTAC sleeve and the frame, further including a shim to maintain the joint for application of a sealant between the lower surface of the PTAC sleeve and the length of the flange which allows water to pass directly from the sleeve to the louver sill thereby eliminating the need to align manufacturer provided weeps in the PTAC sleeve with weeps in the louver.

7. The PTAC louver of claim 2 wherein the header includes an inwardly projecting flange and the sill includes an inwardly projecting flange and wherein each of said flanges engage a PTAC sleeve onto which the louver is mounted.

8. The PTAC louver of claim 7 further comprising a pair of blank-off panels, with each of the pair of panels mounted substantially near each of the opposed jambs of the louver frame and wherein the inner flange of the header, the inner flange of the sill and the opposed pair of blank-off panels cooperate to form a box into which the PTAC sleeve is seated.

9. The PTAC louver of claim 2 further comprising at least one vertical louver retention bar to secure and maintain the positioning and spacing of the louver blades.

10. The PTAC louver of claim 8 further comprising at least one adjustable air diffuser mounted to the interior of the louver.

11. The PTAC louver of claim 9 further comprising at least one adjustable air diffuser adjustably mounted onto the at least one vertical louver retention bar.

12. The PTAC louver of claim 9 further comprising a race formed in the louver retention bar for the receipt, vertical adjustment and securement of fasteners used to connect the louver to a PTAC sleeve.

13. The PTAC louver of claim 8 wherein the blank-off panels are substantially box-shaped and filled with high temperature insulation.

14. The PTAC louver of claim 9 further comprising a plurality of louver blades removably mounted to at least two louver retention bars, and wherein the louver blades are parallel to and positioned between the header and the sill and extending between the opposed jambs.

15. The PTAC louver of claim 8 further comprising a vertical meeting rail mounted generally inward each blank off panel and wherein the meeting rails cooperate with the inner flange of the header and the inner flange of the sill to form a box into which the PTAC sleeve is seated.

16. A PTAC louver assembly comprising a frame having a header, a sill and spaced-apart and opposed vertical jambs, at least two louver blade retention bars positioned between the header and the sill and mounted to a plurality of louver blades, wherein the louver blades are captured and retained within slots provided serially along the louver blade retention bars.

17. The PTAC louver assembly of claim 16 wherein the header, sill and opposed jambs of the frame are mountable within a glazed window wall assembly.

18. The PTAC louver assembly of claim 17 further comprising vertically adjustable and inwardly oriented fasteners positioned within races provided on the louver blade retention bars and the louver blade retention bars are moveable horizontally along the length of the louver blades, and wherein the vertical adjustment of the fasteners within the races and the horizontal adjustment of the louver blade retention bars allow the louver to be mounted to PTAC sleeves from different manufacturers which have different fastener hole configurations after the louver has been glazed into a wall assembly.

19. The PTAC louver of claim 16 further comprising an inwardly projecting flange on the header which forms a joint between the exterior upper surface of the PTAC sleeve and the frame, and the sill further including an inwardly projecting flange which forms a joint between the PTAC sleeve and the frame and an outwardly projecting flange which protects the louver blades.

20. The PTAC louver of claim 19 further comprising a pair of blank-off panels, with each of the pair of panels mounted substantially near each of the opposed jambs of the louver frame and wherein the inner flange of the header, the inner flange of the sill and the opposed pair of blank-off panels cooperate to form a box into which the PTAC sleeve is seated and sealed.

21. The PTAC louver of claim 19 further comprising at least one weep formed in the outer flange of the sill which allows water draining from the PTAC sleeve to freely drain from the louver assembly.

22. A louver blade retention assembly, comprising a plurality of louver blades, a U-shaped strut and a backer slidably received within the U-shaped strut, a plurality of louver blade slots in serial alignment along the length of both the strut and the backer such that when the louver blades are positioned within the serially aligned slots and the backer is moved laterally within the strut, the louver blades are captured within the retention slots by the clamping force created by the movement of the slots formed in the backer retention bar with respect to the slots formed in the struts.

23. The apparatus of claim 21 wherein the backer can be fastened in place with respect to the strut thereby securing the louver blades within the slots by fastening the strut and backer together with a fastener.

24. The apparatus of claim 21 wherein each louver blade includes a nub along its length which is captured and retained in the associated louver blade slot.

25. The apparatus of claim 21 wherein the backer is substantially U-shaped and nested in the U-shaped strut, and wherein the serially aligned slots for receipt of the louver blades are formed in the leg members of the U-shaped strut.

26. The apparatus of claim 21 wherein the backer is substantially T-shaped and nested in the U-shaped strut, and wherein the serially aligned slots for receipt of the louver blades are formed in the leg member of the T-shaped backer.

27. The apparatus of claim 25 further comprising a race formed perpendicular to the leg member of the T-shaped backer for the receipt of a fastener.
